(19) United States
(12) Patent Application Publication
(10) Pub. No.: US 2024/0193797 A1
(43) Pub. Date: Jun. 13, 2024

(54) HUMAN MOTION GENERATION METHOD AND SYSTEM

(71) Applicant: Korea Electronics Technology Institute, Seongnam-si (KR)

(72) Inventors: Bo Eun KIM, Seoul (KR); Jung Ho KIM, Seoul (KR); Sa Im SHIN, Seoul (KR)

(73) Assignee: Korea Electronics Technology Institute, Seongnam-si (KR)

(21) Appl. No.: 18/531,940

(22) Filed: Dec. 7, 2023

(30) Foreign Application Priority Data
Dec. 12, 2022 (KR) 10-2022-0172616

(51) Int. Cl. G06T 7/262; G06F 17/16

(52) U.S. Cl. CPC G06T 7/262; G06F 17/16

(57) ABSTRACT

There are provided a method and a system for generating human motions, which generate motions of an empty frame by using motions in a given frame. A human motion generation method according to an embodiment includes: a first step of transforming, by a system, a domain of pose information of a frame; a second step of generating, by the system, motion features of an empty frame in the transformed domain; and a third step of inversely transforming, by the system, the generated motion features into a time domain. Accordingly, the method and system may effectively generate motions by obtaining a basis vector to be used for transforming a domain of motion trajectory information by training a deep learning-based transform model, transforming a motion trajectory through the basis vector, and inputting the transformed motion trajectory to a motion generation model.

### CROSS-REFERENCE TO RELATED APPLICATION(S) AND CLAIM OF PRIORITY

This application is based on and claims priority under 35 U.S.C. § 119 to Korean Patent Application No. 10-2022-0172616, filed on Dec. 12, 2022, in the Korean Intellectual Property Office, the disclosure of which is herein incorporated by reference in its entirety.

### BACKGROUND

### Field

The disclosure relates to a method and a system for generating human motions, and more particularly, to a method and a system for generating human motions, which generate motions of an empty frame by using motions in a given frame.

### Description of the Related Art

Human motion generation technology includes concepts of motion prediction, motion completion, motion interpolation as shown in FIG. 1, and aims at generating motions of an empty frame by using motions in a given frame.

Related-art motion generation technologies use various artificial intelligence (AI) models such as a graph neural network (GNN) model, a recurrent neural network (RNN) model, a convolutional neural network (CNN) model, or the like.

Specifically, related-art motion generation methods train various AI models by applying trajectories of body joints rather than one-dimensional information such as positions and angles of body joints, and generate motions of an empty frame by using motions in a given frame by using the trained models.

In particular, related-art motion generation methods use a method of transforming trajectories of body joints from a time domain to a frequency domain by using discrete cosine transform (DCT). However, this method uses a basis vector in a fixed cosine form, and has limitations in that it does not well generate various and complicated motions.

In addition, selecting some of basis vectors may be helpful in generating more exact motions, but which basis vector to select may only be known through an experiment with data, and hence, there is a demand for solution to this problem.

### SUMMARY

The disclosure has been developed in order to solve the above- described problems, and an object of the disclosure is to provide a method and a system for generating human motions, which can perform optimal domain transform through a deep learning-based transform model, rather than using a form and a frequency of a fixed basis vector.

Another object of the disclosure is to provide a method and a system for generating human motions, which can generate motions effectively by obtaining a basis vector to be used for transforming a domain of motion trajectory information by training a deep learning-based transform model, transforming a motion trajectory through the basis vector, and inputting the transformed motion trajectory into a motion generation model.

According to an embodiment of the disclosure to achieve the above- described objects, a human motion generation method may include: a first step of transforming, by a system, a domain of pose information of a frame; a second step of generating, by the system, motion features of an empty frame in the transformed domain; and a third step of inversely transforming, by the system, the generated motion features into a time domain.

The first step may include transforming the domain of the pose information of the frame by using a transform model which transforms a domain by applying matrix multiplication to multiply pose information of a frame by a domain transform matrix (spectral transform matrix), and the transform matrix may have elements determined in a training process.

In addition, the second step may include generating the motion features of the empty frame by using trajectory information of body joints included in the pose information in the transformed domain.

In addition, the generated motion features may be implemented by a linear combination of a basis vector.

The second step may use a graph neural network (GNN) model, a transformer model, a convolutional neural network (CNN) model, a multi-layer perceptrons (MLP) model, or a recurrent neural network (RNN) model when generating the motion features of the empty frame.

In addition, the third step may include deriving pose information of each frame by inversely transforming the generated motion features into the time domain.

In addition, the third step may use a deep learning-based inverse transform model to inversely transform the generated motion features into the time domain, and an inverse transform matrix used by the inverse transform model has elements determined in a training process.

The third step may use an inverse matrix of the domain transform matrix (spectral transform matrix) to inversely transform the generated motion features into the time domain.

In addition, the third step may use a transpose matrix of the domain transform matrix (spectral transform matrix) to inversely transform the generated motion features into the time domain.

According to another embodiment of the disclosure, a human motion generation system may include: a communication unit configured to acquire pose information of a frame; and a processor configured to transform a domain of the acquired pose information of the frame, to generate motion features of an empty frame in the transformed domain, and to inversely transform the generated motion features into a time domain.

According to still another embodiment of the disclosure, a human motion generation method may include: a step of training, by a system, a transform model which transforms a domain of pose information of a frame; a step of training, by the system, a motion generation model which generates motion features of an empty frame in the transformed domain; and a step of training, by the system, an inverse transform model which inversely transforms the generated motion features into a time domain.

As described above, according to embodiments of the disclosure, the method and system may perform optimal domain transform through a deep learning-based transform model, so that it robustly operates in response to complicated motions and guarantees best accuracy by automatically learning a forms of an important basis vector without repeating learning.

In addition, the method and system may effectively generate motions by obtaining a basis vector to be used for transforming a domain of motion trajectory information by training a deep learning-based transform model, transforming a motion trajectory through the basis vector, and inputting the transformed motion trajectory to a motion generation model.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view provided to explain a human motion generation technology including motion prediction, motion completion, motion interpolation;

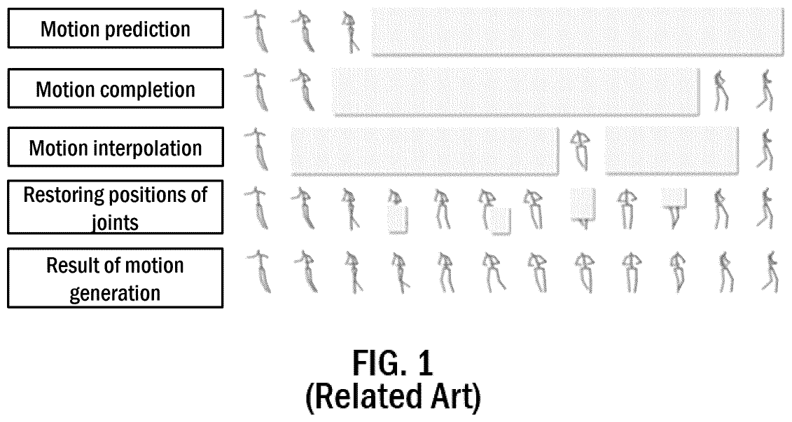

FIG. 2 is a view provided to explain a configuration of a human motion generation system according to an embodiment of the disclosure;

FIG. 3 is a view provided to explain operations of the human motion generation system according to an embodiment of the disclosure;

FIG. 4 is a flowchart provided to explain a human motion generation method according to an embodiment of the disclosure; and

FIG. 5 is a view provided to explain a domain transform process and a domain inverse-transform process according to an embodiment of the disclosure.

### DETAILED DESCRIPTION

Hereinafter, the disclosure will be described in more detail with reference to the accompanying drawings.

A human motion generation system according to an embodiment of the disclosure may perform optimal domain transform through a deep learning- based transform model, rather than using a form and a frequency of a fixed basis vector, in a process of generating motions of an empty frame using motions in a given frame.

In addition, the human motion generation system according to an embodiment may effectively generate motions by obtaining a basis vector to be used for transforming a domain of motion trajectory information by training a deep learning-based transform model, transforming a motion trajectory through the basis vector and inputting the transformed motion trajectory to a motion generation model.

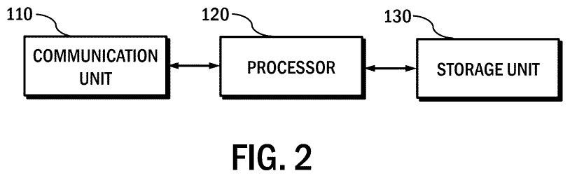

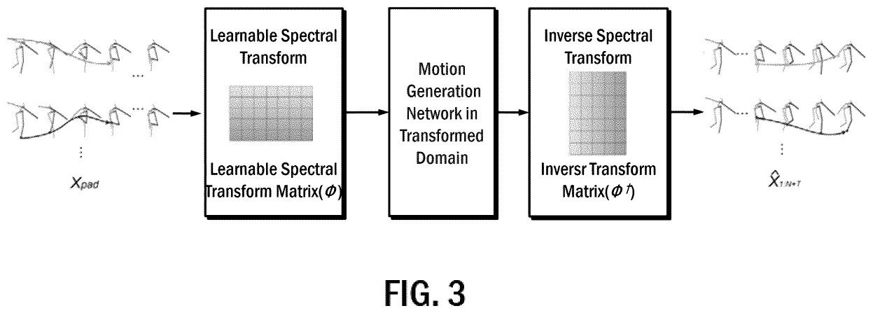

FIG. 2 is a view provided to explain a configuration of a human motion generation system according to an embodiment, and FIG. 3 is a view provided to explain operations of the human motion generation system according to an embodiment.

Referring to FIG. 2, the human motion generation system according to an embodiment may include a communication unit 110, a processor 120, and a storage unit 130.

The communication unit 110 may be connected with an outside to collect information necessary for operating the processor 120. For example, the communication unit 110 may collect pose information of a frame.

The storage unit 130 is a storage medium that stores a program and data necessary for operating the processor 120. For example, the storage unit 130 may store pose information of a frame which is collected through the communication unit 110, and models which are trained by the processor 120.

The processor 120 may process overall matters necessary for generating motions of an empty frame by using motions in a given frame. For example, the processor 120 may transform a domain of the acquired pose information of the frame, and may generate motion features of the empty frame in the transformed domain, and may inversely transform the generated motion features into a time domain.

To accomplish this, the processor 120 may train a transform model which transforms a domain of pose information of a frame, a motion generation model which generates motion features of an empty frame in a transformed domain, and an inverse-transform model which inversely transforms generated motion features into a time domain.

In addition, the processor 120 may derive pose information of the empty frame by using the transform model, the motion generation model, and the inverse-transform model which are trained by using pose information of the frame as input data. Herein, all of the transform model, the motion generation model, and the inverse-transform model may be AI models which are trained based on deep learning.

In addition, the pose information of the frame is information that is expressed by 2D/3D positions of body joints, relative rotation information, quaternion, and may be regarded as a time domain if it is enumerated by frames.

The processor 120 may transform the pose information of the frame which is enumerated by frames into a domain that is effective in calculating by using the trained transform model. Herein, the transform model is a deep learning model that is trained to transform a domain by applying matrix multiplication to multiply pose information of a frame by a domain transform matrix (spectral transform matrix). Herein, elements of the transform matrix are not fixed like a DCT matrix, and are determined by training. That is, the elements of the transform matrix are determined in a process of training the transform model.

In addition, when generating motions features of the empty frame, the processor 120 may generate motion features of the empty frame by applying trajectory information of body joints included in the pose information in the transformed domain to the trained motion generation model. Herein, the motion generation model may be implemented by a graph neural network (GNN) model, a transformer model, a convolutional neural network (CNN) model, a multi-layer perceptrons (MLP) model, or a recurrent neural network (RNN) model.

When inversely transforming the generated motion features into a time domain, the processor 120 may derive pose information of each frame by inversely transforming the generated motion features into a time domain based on the trained inverse-transform model. The inverse-transform model is a deep learning model that is trained to inversely transform a domain by performing an arithmetic operation with respect to pose information of a frame and a domain inverse transform matrix. Herein, elements of the inverse transform matrix are not fixed like an inverse DCT matrix and are determined by training. That is, the elements of the inverse transform matrix are determined in training the inverse transform model.

In another example, the processor 120 may inversely transform the generated motion features into a time domain by using an inverse matrix or a transpose matrix of the transform matrix which is determined through training in the transform model, without using the inverse transform model.

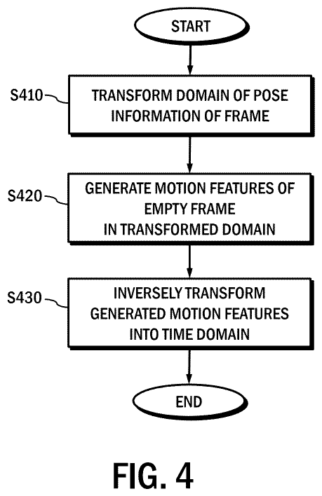

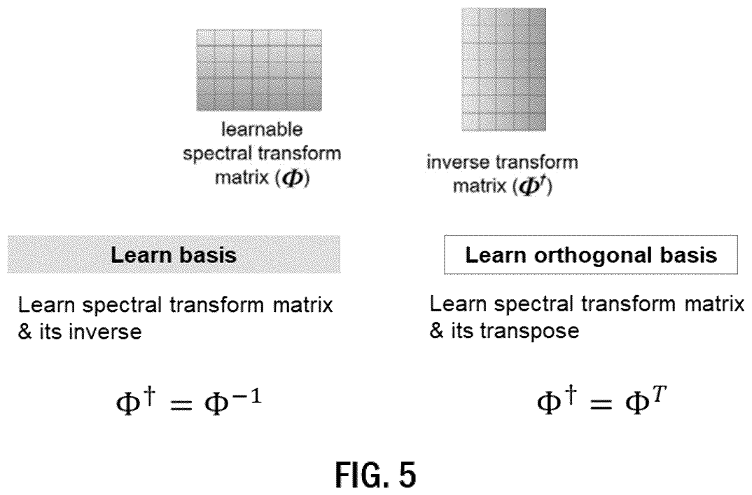

FIG. 4 is a flowchart provided to explain a human motion generation method according to an embodiment of the disclosure, and FIG. 5 is a view provided to explain a domain transform process and a domain inverse-transform process according to an embodiment.

The human motion generation method according to the present embodiment may be executed by the human motion generation system described above with reference to FIGS. 2 to 3.

Referring to FIG. 4, the human motion generation method may transform a domain of pose information of a frame by using the human motion generation system (S410), may generate motion features of an empty frame in the transformed domain (S420), and may inversely transform the generated motion features into a time domain to derive pose information of each frame (S430).

To accomplish this, the human motion generation method may train a transform model for transforming a domain of pose information of a frame, may train a motion generation model for generating motion features of an empty frame in a transformed domain, and may train an inverse transform model for inversely transforming generated motion features into a time domain.

The generated motion features of the empty frame may be implemented by a linear combination of a basis vector. That is, if a domain inverse transform matrix (Φ^{†}) is an inverse matrix of a domain transform matrix (Φ), a column vector of Φ^{†} may be a basis vector. In this case, the human motion generation system may set Φ to a learnable matrix in the process of training the transform model to learn elements thereof, and, when an inverse matrix is calculated as Φ^{†}=Φ⁻¹ for the inverse transform process, may use the inverse matrix in the inverse transform process.

If the domain inverse transform matrix (Φ^{†}) is a transpose matrix of the domain transform matrix (Φ), the column vector of Φ^{†} may be an orthogonal basis vector. In this case, the human motion generation system may set Φ to a learnable matrix in the process of training the transform model to learn elements thereof, and, when a transpose matrix is calculated as Φ^{†}=Φ^{T} for the inverse transform process, may use the transpose matrix in the inverse transform process.

Through the above-described process, the generated motion features may be inversely transformed into a time domain by using the inverse matrix or transpose matrix of the domain transform matrix without using the inverse transform model in the inverse transform process.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

What is claimed is:

1. A human motion generation method comprising:
a first step of transforming, by a system, a domain of pose information of a frame;
a second step of generating, by the system, motion features of an empty frame in the transformed domain; and
a third step of inversely transforming, by the system, the generated motion features into a time domain.

2. The human motion generation method of claim 1, wherein the first step comprises transforming the domain of the pose information of the frame by using a transform model which transforms a domain by applying matrix multiplication to multiply pose information of a frame by a domain transform matrix (spectral transform matrix), and
wherein the transform matrix has elements determined in a training process.

3. The human motion generation method of claim 2, wherein the second step comprises generating the motion features of the empty frame by using trajectory information of body joints included in the pose information in the transformed domain.

4. The human motion generation method of claim 3, wherein the generated motion features are implemented by a linear combination of a basis vector.

5. The human motion generation method of claim 3, wherein the second step uses a GNN model, a transformer model, a CNN model, a MLP model, or a RNN model when generating the motion features of the empty frame.

6. The human motion generation method of claim 2, wherein the third step comprises deriving pose information of each frame by inversely transforming the generated motion features into the time domain.

7. The human motion generation method of claim 6, wherein the third step uses a deep learning-based inverse transform model to inversely transform the generated motion features into the time domain, and wherein an inverse transform matrix used by the inverse transform model has elements determined in a training process.

8. The human motion generation method of claim 6, wherein the third step uses an inverse matrix of the domain transform matrix (spectral transform matrix) to inversely transform the generated motion features into the time domain.

9. The human motion generation method of claim 6, wherein the third step uses a transpose matrix of the domain transform matrix (spectral transform matrix) to inversely transform the generated motion features into the time domain.

10. A human motion generation system comprising:
a communication unit configured to acquire pose information of a frame; and
a processor configured to transform a domain of the acquired pose information of the frame, to generate motion features of an empty frame in the transformed domain, and to inversely transform the generated motion features into a time domain.

11. A human motion generation method comprising:
a step of training, by a system, a transform model which transforms a domain of pose information of a frame;
a step of training, by the system, a motion generation model which generates motion features of an empty frame in the transformed domain; and
a step of training, by the system, an inverse transform model which inversely transforms the generated motion features into a time domain.
